(19) United States
(12) Patent Application Publication
(10) Pub. No.: US 2022/0167129 A1
(43) Pub. Date: May 26, 2022

(54) ELECTRONICALLY ENABLED DRINKING RECEPTACLES

(71) Applicant: simplehuman, LLC, Torrance, CA (US)

(72) Inventor: Frank YANG, Rancho Palos Verdes, CA (US)

(21) Appl. No.: 17/456,453

(22) Filed: Nov. 24, 2021

Related U.S. Application Data
(60) Provisional application No. 63/118,612, filed on Nov. 25, 2020.

(51) Int. Cl. H04W 4/30; G08B 5/36; A47G 23/16

(52) U.S. Cl. CPC H04W 4/30; A47G 23/16; G08B 5/36

(57) ABSTRACT

This disclosure includes a description of an electronically enabled drinking receptacle that has a liquid container, an electronic processor, an electronic drinking monitor, and a user-communicator. The drinking monitor can provide information to the electronic processor regarding an amount of liquid withdrawn from the liquid container over time and the electronic processor can be configured to actuate the user-communicator to communicate information to a user. The user-communicator can include one or more lights on the drinking receptacle, and the information communicated to the user can be configured to encourage the user to drink more liquid. The drinking receptacle can include an electronic communicator configured to communicate information between the liquid container and a separate electronic device, which can be remote from the drinking receptacle. The separate electronic device can be a mobile electronic device such as a wearable mobile electronic device.

### REFERENCE TO RELATED APPLICATIONS

This application claims the benefit of U.S. Provisional Application No. 63/118,612 filed Nov. 25, 2020. This application hereby incorporates by reference the above-identified provisional application in its entirety.

### BACKGROUND

### Field

This disclosure relates generally to drinking receptacles and specifically to drinking receptacles with one or more electronic features.

### Description of the Related Art

The many significant health benefits of drinking a large amount of water on a daily basis are clear and well established, but most people do not do it. The main reason for this problem is simply that most people do not think about the need to continuously drink water throughout the day or keep track of how much water they have been drinking.

In a related problem, in many group settings, such as with families, roommates, schools, work places, or other gatherings, multiple drinking receptacles with a similar or identical appearance may be used by different individuals. Unless a full beverage is imbibed in a single instance, it can be difficult to keep track of what drinking receptacle belongs to what person, and consequently how much each person has drunk.

### SUMMARY

This disclosure includes a description of an electronically enabled drinking receptacle that has a liquid container, an electronic processor, an electronic drinking monitor, and a user-communicator. The drinking monitor can provide information to the electronic processor regarding an amount of liquid withdrawn from the liquid container over time and the electronic processor can be configured to actuate the user-communicator to communicate information to a user. The user-communicator can include one or more lights on the drinking receptacle, and the information communicated to the user can be configured to encourage the user to drink more liquid. The drinking receptacle can include an electronic communicator configured to communicate information between the liquid container and a separate electronic device, which can be remote from the drinking receptacle. The separate electronic device can be a mobile electronic device such as a wearable mobile electronic device.

This disclosure also includes a description of an electronically enabled drinking system that includes a liquid container, an electronic processor, an electronic drinking monitor, an electronic user-communicator, and an app on an electronic device separate from the liquid container. The drinking monitor can be configured to provide information to the electronic processor regarding the liquid container and the electronic processor can be configured to communicate the information to the app on the electronic device, such as a mobile electronic device which can be wearable such as a watch or wristband.

This disclosure also includes a description of a system of electronically enabled drinking receptacles comprising a plurality of drinking receptacles, each of which includes an electronic communicator and a user communicator. The drinking receptacles can be configured to communicate electronically with each other through the electronic communicators and to communicate with one or more users using the user communicators.

### BRIEF DESCRIPTION OF THE DRAWINGS

Some of these drawings are schematic, showing some examples of basic parts and concepts. Many different or additional structures, implementations, components, mechanisms, steps, and processes can be used. The claimed inventions should not be limited in any way to anything illustrated in the drawings.

FIG. 1 is a schematic illustration of a drinking receptacle;

FIG. 2 is an illustration of an example of the receptacle of FIG. 1 in the form of a closed-topped liquid container, shown as both an outer front elevational view and a vertical cross-sectional view;

FIG. 3 is front elevational view of an illustration of an example of the receptacle of FIG. 1 in the form of an open-topped drinking cup;

FIG. 4 is partial cross-sectional or transparent view of a portion of an example of an implementation of the drinking cup of FIG. 3;

FIG. 5 is collection of multiple drinking receptacles in communication with each other.

FIG. 6 is a schematic illustration of an example of a drinking receptacle in communication with a separate electronic device.

### DETAILED DESCRIPTION

This specification provides textual descriptions and illustrations of many devices, components, assemblies, and subassemblies. Any structure, material, function, method, or step that is described and/or illustrated in one example can be used by itself or with or instead of any structure, material, function, method or step that is described and/or illustrated in another example or used in this field. The text and drawings merely provide examples and should not be interpreted as limiting or exclusive. No feature disclosed in this application is considered critical or indispensable. The relative sizes and proportions of the components illustrated in the drawings form part of the supporting disclosure of this specification, but should not be considered to limit any claim unless recited in such claim.

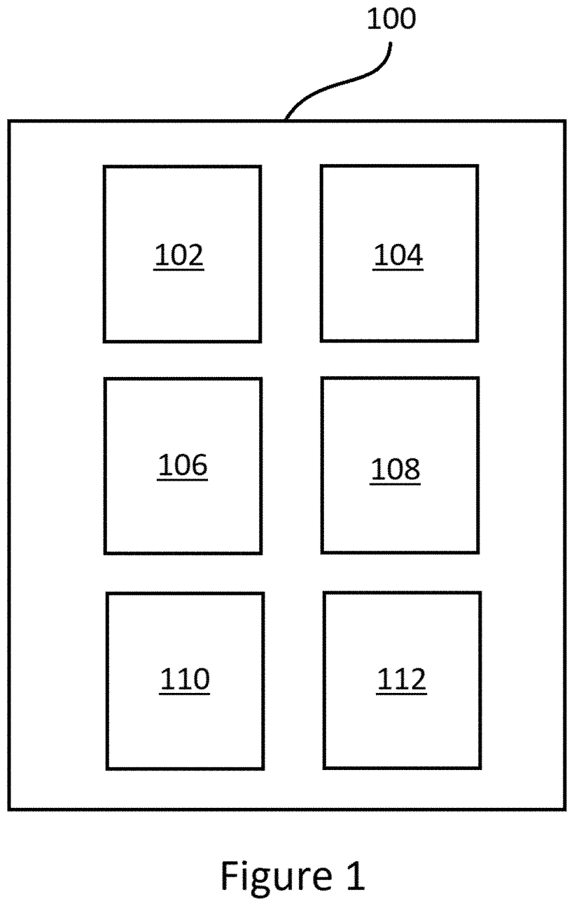

As illustrated in FIG. 1, a drinking receptacle 100 can comprise one, two, or more features including a liquid-containing portion 102, an electronic processor 104, a power source 106, a user-communicator 108, an electronic communicator 110, and/or an electronic measuring instrument 112. Any of these features or components can be included or omitted in the drinking receptacle 100, and any additional features can be added, including any additional features disclosed or illustrated elsewhere in this specification or otherwise.

In some examples, the liquid-containing portion 102 can be an open-topped drinking cup or “glass,” or a closed or closeable container, bottle, or vessel (e.g., with a selectively removable or openable lid or cap). The liquid-containing portion 102 of the drinking receptacle 102 can be made of, or can include any components that are made of, any suitable material such as a polymer (e.g., plastic), a metal (e.g., stainless steel), a glass or crystal, and/or a ceramic or stone, or any composite or combination of any of the foregoing. Any other suitable materials can be used.

In some implementations, the liquid-containing portion 102 can be sufficiently large to provide enough water for an adult or child for several hours or a day of normal, healthy consumption but not so large as to be inconvenient to hold or carry for a typical user. The drinking receptacle 100, including the electronics, can be sufficiently robust and housed or contained in a water-tight manner, such as with one or more gaskets and seals, to permit thorough cleaning, such as in an automatic dish washer. In some embodiments, the entire or at least a portion of the electronics in the drinking receptacle 100 can be conveniently separable from the drinking receptacle by a user without tools in order to selectively use the liquid-containing portion 102 separately or to enable cleaning of the liquid-containing portion 102 without exposing the electronics to the rigors and increased wear that may be associated with thorough liquid and/or heated cleaning. The drinking receptacle 100 can be insulated to generally maintain, or to substantially slow a change in, the temperature (e.g., cold or hot) of the contained liquid for an extended period, such as for multiple hours.

In some examples, the electronic processor 104 can be any suitable electronic processor, including but not limited to an electronic processor capable of or configured to direct, coordinate, or choose among different electronic options, communicate with other electronic components, and/or execute electronic code that is stored on, accessible to, or received by the electronic processor 104, such as an integrated circuit, a central processing unit, a microprocessor, a microcontroller, and/or a collection of basic electronic components, etc. The processor 104 can be attached in wired or wireless communication with any other or all of the other electronic components of the drinking receptacle 100. The electronic processor 104 can include or can be in wired or wireless communication with an electronic memory.

In some examples, the power source 106 can be any suitable source of electrical power, including a connection point configured to receive a wire or an assembly that includes a wire for directly attaching to a source of electrical power such as a wall socket, a replaceable or rechargeable battery (e.g., configured to be recharged through a wire or wirelessly such as by electromagnetic induction), a solar-powered unit such as a solar cell, or any other suitable source of electrical power. The power source 106 can be in electrical communication with any or all of the electronic components of the drinking receptacle 100.

The user-communicator 108 can comprise any component or collection of components that is or are configured to communicate information or commands directly to and/or from a user of the drinking receptacle 100. In some examples, the user-communicator 108 can be or can include one or more of the following: a light or a series of lights that can display one or more colors; an illuminator that can include a light that illuminates one or more other components or parts of the drinking receptacle 100 in one or more colors; a speaker or other audio device; a microphone; a vibrator or haptic device; a display screen, such as a touch-enabled display screen; a user biometric sensor (e.g., a fingerprint sensor, a retinal scanner, a facial recognition camera, etc.); and/or a button, a series of buttons, a capacitive touch device, a user-input pad; and/or a switch or a dial, etc.

The electronic communicator 110 can comprise any component or collection of components that is or are configured to communicate information or commands to or from another electronic device that is separate or separable from the drinking receptacle 100. For example, in some embodiments, the electronic communicator 110 can be or can include one or more of the following: a wireless communicator such as a wireless network interface controller (e.g., a controller configured to communicate using Wi-Fi, Bluetooth, ZigBee,

Z-Wave, or any other suitable wireless network protocol); a cellular or mobile-phone-type communicator or modem; a near-field communication device (e.g., RFID); and/or a wired connection, etc. Any other suitable electronic communicator 110 can be used. In some embodiments, the electronic communicator 110 can be configured to communicate with any other electronic device, such as: a mobile electronic device (e.g., a mobile phone, tablet, or laptop computer, etc.); a user-wearable communicator (e.g., a bracelet, a watch, an armband or wristband, a haptic device, an earphone, a headset, a communication patch, etc.); a desk-top computer, a server, and/or a router; and/or a voice-controlled electronic personal assistant or smart speaker, etc.

In some examples, the electronic measuring instrument 112 can comprise any component or collection of components that is or are configured to measure, monitor, determine, track, store, and/or evaluate over time one or more useful metrics relating to the drinking receptacle 100. For example, in some embodiments, the measuring instrument 112 can be or can include one or more of the following: volume-sensing or weight-sensing devices (e.g., a strain gauge, one or a series of break-beam IR sensors, a weight scale, an electrical capacitance or resistance sensor, and/or a distance-measuring device such as a time-of-flight or ToF camera or sensor, etc.), thermometers or temperature-measuring devices, orientation-measuring devices (e.g., a gyroscope and/or a tilt-switch such as a mercury switch), location-sensing devices (e.g., a global positioning or GPS device), and/or motion-sensing devices (e.g., an accelerometer). The measuring instrument 112 can include or can be in wired or wireless communication with an electronic memory. In some embodiments, the electronic measuring instrument 112 can measure and/or calculate how much volume or weight of liquid is present in the drinking receptacle 100 or has been used or taken from the drinking receptacle 100 within a specified time period, how fast the drinking receptacle 100 is moving or how far it has moved, where the drinking receptacle 100 is located, what the temperature is in the environment of the drinking receptacle 100 over different time intervals, how many sips have been taken from the drinking receptacle 100 within a specified time period, etc. Any electronic measuring instruments 112 that determine, estimate, measure, or calculate an amount of liquid that is currently present in, or has been removed over time from, the liquid-containing portion 102 can be referred to as drinking monitors.

All embodiments disclosed in this specification illustrate and/or describe features that can be used with or in the drinking receptacle 100 illustrated in FIG. 1. It is contemplated that any combination of features from any embodiment or multiple embodiments in this specification can be used with or in the drinking receptacle 100 illustrated in FIG. 1.

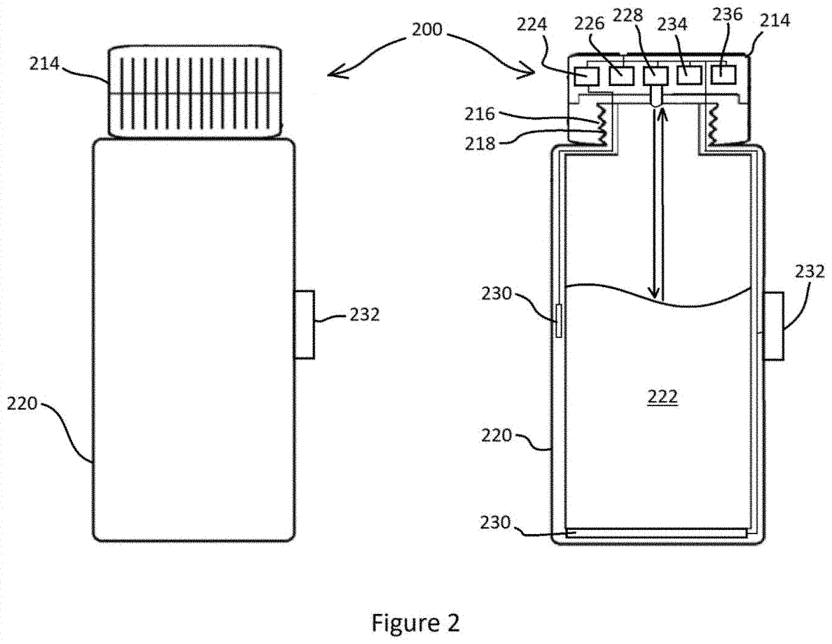

As illustrated in FIG. 2, in some embodiments, a drinking receptacle 100 can be provided in the form of a closeable liquid container 200 with a lid 214. The liquid container 200 can include any or all of the features described or illustrated in connection with the drinking receptacle 100 (including anything in any other embodiment), and the drinking receptacle 100 can include any or all of the features described or illustrated in connection with the closeable liquid container 200.

In some embodiments, the lid 214 can comprise a connecting surface 216 such as screw threads as shown that is configured to removably attach to and/or form a liquid-tight seal with a connecting surface 218 such as corresponding screw threads on a liquid holder 220. The liquid holder 220 can be configured, in conjunction with the lid 214, to contain a quantity of any consumable liquid 222, such as water, juice, coffee, medication, etc. Multiple components can be included on or in any suitable component or portion of the liquid container 200, such as on or in the lid 214 and/or on or in the liquid holder 220, as shown in the illustration or otherwise.

In the example shown in FIG. 2, a processor 224 can be provided in any suitable location, such as in the lid 214 (as shown) or in the liquid holder 220 or in any other location. The processor 224 can be in electrical communication with any or all other electronic components included in the liquid container 200 via a series of wires, leads, electrically conducting contacts, and/or via wireless communication. The processor 224 can include an electronically readable and writable memory for storing code or computer instructions and/or data relating to the use of the liquid container 200. The processor 224 can include a clock or timer that is configured to electronically measure the time of day and/or the amount of time that has passed or elapsed between any given set of events to calculate, store in memory, and/or communicate information regarding any measured function, attribute, or characteristic of the liquid container 200 as a function or time or at a particular time. For example, the clock or timer can be used to measure the time between drinks or sips from the liquid container 200 or the time that has elapsed since the last drink or sip. A power source 106 in the form of a rechargeable battery 226 can be provided in electrical communication with the processor 224 and each other electronic component in the liquid container 200. The battery 226 can be recharged by attaching a wire to a port provided on the lid 214 of the liquid container 200 or by electromagnetic induction.

The liquid container 200 can include an electronic measuring instrument 112 in the form of a liquid volume estimator 228 that is configured to estimate or calculate the volume of liquid held within the liquid holder 220 at a particular time and/or to keep track of how the volume of liquid held within the liquid holder 220 has changed as a function of time over a given time interval. In the illustrated example, the volume estimator 228 comprises a ToF device that is configured to emit a signal toward the top surface of the liquid 222 in the liquid holder 220, such as an electromagnetic signal or a sound wave, that contacts the liquid 222 and reflects at least in part back toward a detector in the ToF device. Using the time elapsed between the emission and detection of the signal, the ToF device and/or the processor 224 can calculate or estimate the distance between the lid 214 and the top surface of the liquid 222. Since the distance between the lid 214 and the bottom surface of the liquid holder 220 is a known, fixed quantity, the measured distance between the lid 214 and the top of the liquid 222 can be subtracted from this quantity to yield the height of the liquid 222 within the liquid holder 220, from which the volume of liquid 222 within the liquid holder 220 can be calculated based upon a known, fixed diameter or cross-sectional area of the interior cavity of the liquid holder 220. By measuring the amount of liquid 222 within the liquid holder 220 at a plurality of times or over an interval of time, the amount of liquid 222 consumed by the user within that interval can be measured, calculated, or estimated. Since the liquid 222 does not have a fixed form and can change in shape (such as in response to motion or changing orientation of the container, fluid dynamics, and/or gravitational forces), multiple measurements using the volume estimator 228 can be taken over a short time and averaged to arrive at a more precise instantaneous value that can eliminate or diminish the influence of sloshing or jostling of the liquid holder 220.

In some embodiments, as shown, an additional or alternative mode of measuring or calculating the volume or liquid 222 within the liquid holder 220 can be performed using a measuring instrument 112 in the form of a weight scale 230. The weight scale 230 can be configured to measure the weight of the liquid 222 by measuring the downward gravitational force exerted on a bottom plate of the liquid holder 220. Since most consumable liquids are water-based, and the weight per volume of water is a known, fixed quantity (1 gm/cm³ or about 62.4 pounds per cubic foot), the volume of a water-based liquid can be calculated from a measured weight of such liquid, either by the weight scale 230 or by the processor 224.

As with any measurement or condition disclosed in this specification, a memory, such as a memory included in the processor 224, can be configured to store a volume of liquid 222 held within the liquid holder 220 at a particular time or over a plurality of times to derive a total amount of liquid consumed over a particular time or an average rate of liquid consumption on a particular day (or any other period) or in any other helpful calculations or measurements.

The liquid container 200 can include a user communicator 108 or a plurality of user communicators 108 in the form of one or more lights and/or illuminators 230. If the communicator 108 is a lighting unit by itself, then it can emit light directly to be seen by a user; and if the communicator is an illuminator 230, then it can be a lighting unit that emits light that is received into and/or reflected by another component of the liquid container 200, such as a transparent, partially transparent, partially opaque, and/or reflective surface such as a wall or lid of the liquid holder 220 that is configured to disperse, reflect, and/or diffuse the light, which then can be visible by a user. The one or more lights or illuminators 230 can be capable of turning on or off, and/or emitting light in a plurality of colors, in a way that can communicate one or more messages or information to a user, such as any messages or information described anywhere in this specification or otherwise. The one or more lights or illuminators 230 can be capable of emitting light in a pattern or in pulses with characteristics that can communicate one or more of such messages or information to a user.

The liquid container 200 can include a user communicator 108 in the form of a biometric sensor, such as a fingerprint sensor 232, that can be in electrical communication with the processor 224 and the battery 226, as shown. In some embodiments, as illustrated, the fingerprint sensor 232 can be positioned on a side of the liquid container 200 where a user's finger or thumb in normal use can be used to grip the liquid container 200. The fingerprint sensor 232 can communicate information to the processor 224 and a memory about the user's finger or thumb that can help identify which of a plurality of users is using the liquid container 200 to help keep track of liquid-consuming information for that particular user, and/or to set one or more preferred modes or use for such user from a plurality of different modes of use, which can be helpful when the same liquid container 200 may be cleaned out and used at different times by different users. The one or more different modes of use can include one or more different displayed colors, one or more pulses or patterns of light emitted, and/or information that permits the liquid container 200 to communicate with one or a plurality of separate mobile electronic devices that belongs to a particular user.

As shown, in some embodiments, the liquid container 200 can include an electronic communicator 110 in the form of a wireless network interface controller 234 configured to communicate with one or more other devices, such as by using any Wi-Fi or Bluetooth compliant electromagnetic signals. The electronic communicator 110 can be configured to communicate electronically with the processor 224, as well as with any electronic memory within or separate from the processor 224, to transmit information that is calculated, measured, and/or stored by the liquid container 200. The electronic communicator 110 can communicate any suitable or helpful information, including anything stored in the electronic memory.

The liquid container 200 can include an electronic thermometer 236, as illustrated. The thermometer 236 can be configured to measure ambient temperature outside of the liquid container 200 and/or to measure the temperature of the liquid inside of the liquid container, and to store one or more values associated with these temperature measurements in an electronic memory associated with the liquid container 200. The temperature can be recorded over time and correlated with the amount of water consumed by a user and/or recommended to be consumed by a user. The temperature of the contents of the liquid container can be communicated to the user via one or more user communicators 108, for example by glowing red when the temperature of the liquid in the container is too hot to be imbibed, by glowing blue when the temperature of the liquid is cold, and/or by glowing green when the temperature of the liquid in the container is at an acceptable temperature to be imbibed.

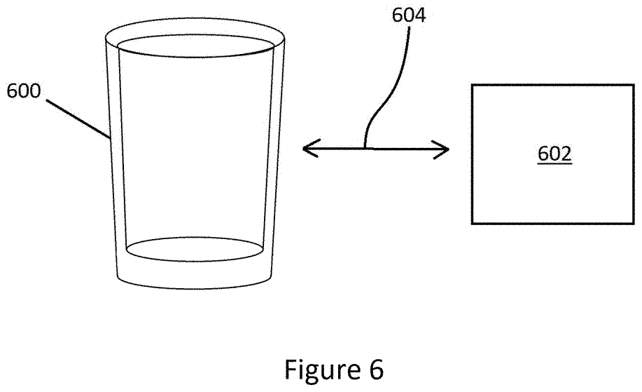

A dynamic algorithm in the processor 104 or in a memory, or in a separate electronic device 602 (see FIG. 6), can be provided that is capable of calculating a different recommended amount of water to be consumed by a user depending on physiological characteristics of the user (which may be provided to the processor 104 or to the separate electronic device 602 by the user), the ambient temperature, the amount of movement of the drinking receptacle 100 (which can serve as a measure of the user's physical exertion, requiring greater or lesser water intake), and/or one or more additional dynamic values. In some embodiments, when the measured ambient temperature exceeds a particular threshold for a particular period, the recommended amount of water to be consumed by the user can be increased to a higher amount from a normal or standard recommended amount (e.g., by decreasing the period between messages, information, or alerts communicated to the user recommending drinks). For example, if the ambient temperature is measured to be at least about 80 degrees Fahrenheit for at least about 30 minutes, then the liquid container 236 by way of the processor 224 or separate electronic device 602 can communicate to the user through one or more user communicators 108 (e.g., one or more blinking lights or one or more lights of a particular color or colors such as red, one or more digitally displayed messages, one or more sounds, one or more vibrations, etc.) that the user should drink water more frequently than normal.

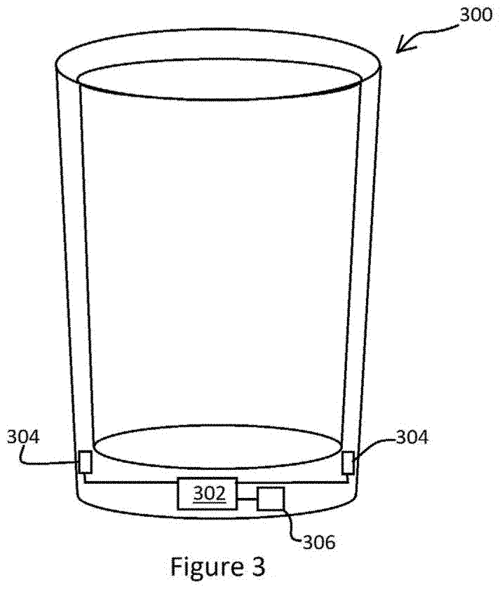

Regarding FIG. 3, in some embodiments, a drinking receptacle 100 in the form of a liquid cup 300 can include any or all of the features described or illustrated in connection with the drinking receptacle 100 (including anything in any other embodiment), and the drinking receptacle 100 can include any or all of the features described or illustrated in connection with the liquid cup 300. In some embodiments, the liquid cup 300 can have an open, non-closing top as shown. The cup 300 may include a combination electronic computer 302 that includes an electronic processor 104 including a clock or timer and a memory, a rechargeable power source 106, and an electronic communicator 110. The electronic computer 302 can be electrically coupled by wire leads and/or provided with wireless communication with one or more other electronic devices, such as one or more user communicators 108 in the form of one or more illuminators or lights 304 positioned or embedded in or on a wall of the liquid cup 300, and/or an electronic use-measurer such as a tilt-measurer 306 that is configured to measure and store in the memory when and/or the number of instances that the liquid cup 300 is tilted for drinking over time, such as by using a gyroscope device or circuit or a tilting switch such as a mercury switch.

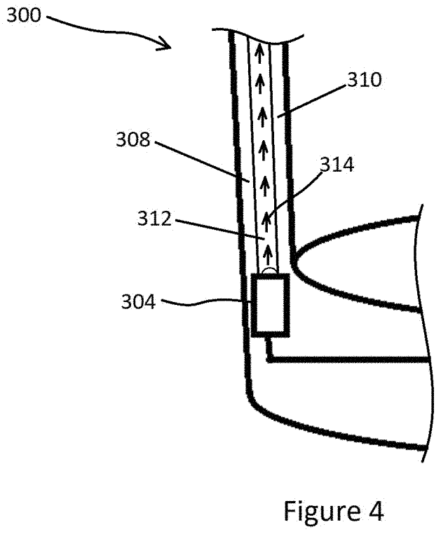

As shown in FIG. 4, in some implementations, the one or more illuminators or lights 304 can be positioned in various positions on or within the cup 300. As shown, multiple illuminators or lights 304 can be provided on the cup 300 such that however the cup 300 is oriented or positioned with respect to the user, at least one illuminator or light 304 can be positioned to emit light, either directly or indirectly, toward the user.

As illustrated, in some embodiments, one or more lights 304 such as one or more light-emitting-diodes (LEDs) can be positioned within a wall, such as a side wall or bottom wall of the cup 300, in between an inner wall portion 310 and an outer wall portion 308, such that a space 312 is provided between these walls 310, 308 into which a light beam 314 can be emitted by the one or more lights 304. The space 312 can be empty (e.g., just air) or the space 312 can include a light transmission channel, reflector, or diffuser. For example, in some embodiments, the space 312 can include an interior diffusion or reflective layer comprising a paper or fibrous material, a metallic sheet, a network of filaments such as wire, one or more fiber optic cables, a randomized reflective material such as one or more sheets, materials, or suspensions with reflectors such as glitter or sparkles. In some embodiments, there is no space 312 or open gap between wall portions but any of these materials can be provided within, embedded in, layered tightly between, or attached on the outside or inside of either or both wall portions 310, 308 or a monolithic wall of the cup 300. In some embodiments, one or more portions of the wall of the cup 300 can be frosted or rendered partially transparent or partially opaque such that at least a portion or substantially all of the outer surface area of the cup can be made to selectively glow by directing light into it. By using one or more diffusing or reflective materials, the wall of the cup 300 itself can be utilized to enlarge, spread out, magnify, or otherwise increase the visibility of the light emitted by the cup 300. Any of these lighting structures or methods can be used to communicate one or more messages to, or provide entertainment for, a user.

In some uses, the cup 300 can initially be filled with a liquid such as water. In a first or initial phase, the one or more lights or illuminators 304 can be set by the computer 302 in a first mode to indicate that no drink needs to be taken. For example, in this phase, the one or more lights or illuminators 304 on the cup can be turned off or can be actuated to emit a first color (e.g., green) or pattern of light (e.g., steady glow or dim glow). As time passes, if the tilt-measuring device 306 does not indicate that the cup 300 has been tilted for drinking within a pre-determined amount of time (e.g., at least about 30 minutes), then the computer 302 can set the one or more lights or illuminators 302 in a second or subsequent phase in which a second color (e.g., red or orange) and/or pattern of light (e.g., flashing or pulsing light) is shown. The time duration of a tilt can also be measured and recorded to enable the processor to estimate the amount or volume of liquid imbibed during a particular drink and to thereby keep track of the total amount or volume of liquid remaining in the cup 300 and the total amount or volume of liquid imbibed by a user over a given period of time (e.g., a day). In some embodiments, the cup 300 can include a speaker or other audio or haptic device that emits a sound, vibration, or other signal, to communicate when a predetermined time has passed since the last drinking use of the cup 300 or to communicate any other information, signal, message, or alert. The sound can be any sound, such as a beep or chirp, or a voice emitted from a speaker that states words of affirmation, instruction, and/or information to a user such as “You're drinking enough water” (reinforcing proper drinking) or “It's time to drink more water” (encouraging to drink more) or “You've drunk half of the water that you need for today” (providing the status of drinking progress). The cup 300 can be configured to communicate to the user in a manner that encourages a user to drink sufficient liquid throughout the day by providing alerts or information to the user.

In any embodiment disclosed in this specification, the drinking receptacle 100 can be configured to alert a user or another person when the user has consumed too much of a particular liquid or is getting close to consuming too much of a particular liquid. For example, in the case of alcoholic liquids, the drinking receptacle 100, or any software or app associated with a separate electronic device 602 capable of communication with the drinking receptacle 100 (see FIG. 6), can be configured to set a predetermine limit or maximum on the amount of a particular liquid that a user should drink. In some embodiments, the alcohol content of the liquid can be provided in a look-up table or through the internet, or by a user or automatically, which can be used by the processor 104 or the separate electronic device 602 to calculate a safe amount of drinking without impairment. The legal blood-alcohol limit for driving a vehicle in the applicable jurisdiction where the user is located can be provided in the processor 104 or in software or in an app on the separate electronic device 602, or inputted by the user. The processor or software or an app associated with the drinking receptacle 100 can take into account physiological factors, such as a user's height and/or weight, to calculate an appropriate number of drinks or sips of a particular type of alcoholic beverage that would be permissible before a particular user would exceed the legal limit. When a user is approaching or has exceeded this amount of consumption, the drinking receptacle 100 or the separate electronic device 602 can send an alert to the user or to one or more other persons using a user communicator 108 or through the electronic device 602 in any of the ways disclosed elsewhere in this specification or otherwise.

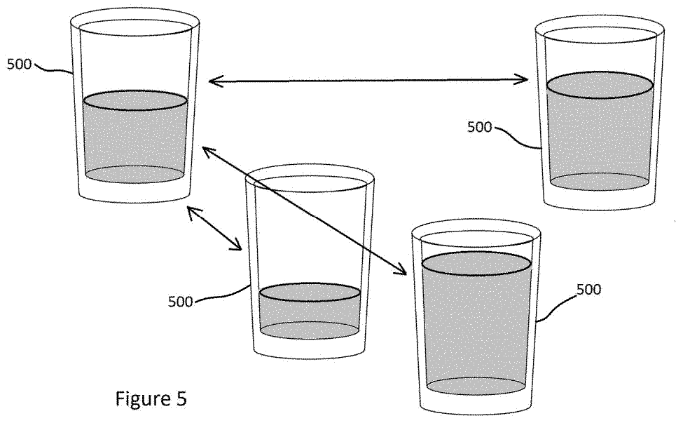

Regarding FIG. 5, in some embodiments, a drinking receptacle 100 in the form of a liquid cup 500 can include any or all of the features described or illustrated in connection with the drinking receptacle 100 (including anything in any other embodiment), and the drinking receptacle 100 can include any or all of the features described or illustrated in connection with the liquid cup 500. In some embodiments, multiple drinking receptacles 100 which are here illustrated as group-enabled cups 500 can communicate with each other for various purposes, such as to monitor drinking patterns of a group or of individuals or subsets of a group, to segregate or identify individual cups 500 in a group setting, to provide an aesthetically pleasing or entertaining display, and/or to communicate messages to individuals or groups.

As shown, a plurality of cups 500 that may contain or include any or all of the features described and/or illustrated in any other embodiments in this specification can be configured to communicate information directly between or among the cups 500 or through the medium of a network such as a Wi-Fi network or other communication means. For example, one or more of the cups 500 can be configured to determine by way of one or more electronic communicators 110 that two or more cups 500 are in close proximity to each other. In some embodiments, the cups 500 can automatically, or after communicating with a user, display different colors or light patterns from each other to ensure that each user of a particular cup 500 knows that the cup 500 belongs to him or her and does not get mixed up with someone else's cup 500. For example, while multiple cups 500 are in close proximity for a set period of time or until reset, one cup 500 can illuminate in red, another cup 500 in blue, another cup in green, etc., and/or each cup 500 can illuminate with a different pattern of dynamic blinking or flashing lighting.

In some embodiments, such as during a game when participants are designated to drink in a predetermined or random order, one or more of the cups 500 can be configured to designate a particular drinker at a particular time to take a drink. In some embodiments, one or more of the cups 500 can be configured to determine by way of any of the drinking sensors or measuring instruments disclosed herein when a particular user of a cup 500 has imbibed a substantially different amount of liquid over a pre-determined time period than other nearby users of cups 500, for example a user who has consumed too much alcohol can be identified by way of one or more user-communicators 108 in the user's cup 500 such as by turning red or flashing.

In some embodiments, the cups 500 can be configured to communicate with each other through electronic communicators 110 and to display using user-communicators 108 a pattern of illumination or sound that is entertaining or aesthetically pleasing, such as a sequential, synchronous, or coordinated display of colors, pulses, flashes, or sounds when a group of cups 500 are present in proximity, such as in a party or other group setting. In some embodiments, one or more of the cups 500 can include a microphone that is capable of receiving sounds such as music, or otherwise obtain information about such sounds or music, and then one or more of the processors 104 in the cups 500 can dynamically actuate lighting to synchronize colors and patterns among the group of cups 500 to correspond to the rhythm or beat of the music.

As shown in FIG. 6, one or more drinking receptacles 100, such as in the form of a cup 600 (as illustrated) or a bottle or any other type of receptacle, can be configured to be in communication by any suitable electronic means 604 (directly as illustrated, sequentially, or via a network, or by way of one or more other devices) with a separate electronic device 602, such as by Wi-Fi, Bluetooth, or any other means. The cup 600 can include any or all of the features described or illustrated in connection with the drinking receptacle 100 (including anything in any other embodiment), and the drinking receptacle 100 can include any or all of the features described or illustrated in connection with the liquid cup 600. The electronic means can be any electronic communicator 110 described and/or illustrated in this specification or otherwise. In some embodiments, the separate electronic device can be a generally fixed-position or generally stable-position device such as a router, a server, a desk-top computer and/or a generally portable or frequently moving mobile electronic device, such as a mobile phone, a tablet computer, a laptop computer, a key fob, etc. The mobile electronic device 602 can be wearable, such as a bracelet, watch, necklace, ring, earpiece, hat, shoe, article of clothing, etc. In some embodiments, the separate electronic device 602 can be configured to communicate remotely from the cup 600, such as wirelessly or far enough away that the cup 600 and the electronic device are not in the same room or not within visible line or sight from each other.

In some embodiments, the communication between the cup 600 and the separate electronic device 602 can provide one or more functions using the processor 104 in the cup 600 and/or an app or software or hardware on the separate electronic device 602, such as:

(a) reporting, calculating, and/or communicating information from the cup 600 to the separate electronic device 602, including information about drinking patterns (e.g., frequency and/or time of drinking, frequency and/or time of filling or refilling of liquid, volume of liquid drunk, movement or location of the liquid cup 600, ambient temperature of the liquid cup 600 or temperature of the liquid, etc.) of a particular user or group of users over time or at a plurality of different times (including in situations where the separate electronic device 602 is configured to communicate with a plurality of cups 500), which the electronic device 602 can analyze, store, and display in ways that are meaningful to a user using graphs, charts, alerts, and/or guidance about how to improve drinking habits or patterns of one or more users; and/or

(b) communicating commands or settings from the electronic device 602 to the cup 600, such as to reset, change users, turn off, etc., and/or to specify a particular amount of liquid that is desired to be consumed by a user during a particular period, which can enable the processor 104 in the cup 600 and/or an app or software or hardware on the separate electronic device 602 to determine how often and how much liquid to prompt the user to consume over such period, or one or more user preferences about how the cup 600 will communicate using one or more user-communicators 108 (e.g., enabling a user to choose among a plurality of light colors, light patterns, sounds, vibrations, spoken messages, etc. for particular messages or other displays by one or more cups 600), and/or any other settings or conditions described and/or illustrated in this specification or otherwise. The separate electronic device 602 can be configured to command the cup 600 to actuate a user communicator 108 in any suitable way to alert a user as to the location of the cup 600 when it is lost, such as by causing the cup 600 to emit a sound and/or turn on a flashing light.

The cup 600 and/or the separate electronic device 602 can be configured to determine through communication of electronic signals, directly or over a network, the approximate distance between the cup 600 and the separate electronic device 602. A message, such as an alert or alarm, can be provided to a user of the cup 600 and/or the separate electronic device 602 in any way disclosed anywhere in this specification or otherwise to indicate that the cup 600 may have been forgotten, lost, or left behind based upon the distance between the cup 600 and the separate electronic device 602.

In some embodiments, the cup 600 can be configured to provide stored, instantaneous, or generally real-time information or communication to the separate electronic device 602, such as through a processor 104, memory, and/or an electronic communicator 110, so that a monitoring person in possession of the electronic device 602 who is different from the drinker of the cup 600, such as a parent of a young child in school, can receive and review information and activity related to the cup 600 using the separate electronic device 602.

In some embodiments, the cup 600 can communicate to a user by way of an electronic communicator 110 rather than, or in addition to, a user communicator 108 on the cup 600. For example, instead of or in addition to causing the cup 600 itself to light up, vibrate, or make one or more sounds to communicate with a user (e.g. when a user needs to take a drink), the cup 600 can communicate to a user by sending a suitable message through an electronic communicator 110 to a separate electronic device 602 that itself can include a user communicator 108 of any suitable type for conveying a message to the user.

1. An electronically enabled drinking receptacle comprising:
a liquid container comprising:
an electronic processor;
an electronic drinking monitor; and
a user-communicator;
wherein the drinking monitor is configured to provide information to the electronic processor regarding an amount of liquid withdrawn from the liquid container over time and the electronic processor is configured to actuate the user-communicator to communicate information to a user.

2. The drinking receptacle of claim 1, wherein the user-communicator comprises one or more lights on the drinking receptacle.

3. The drinking receptacle of claim 1, wherein the information communicated to the user is configured to encourage the user to drink more liquid.

4. The drinking receptacle of claim 1, further comprising an electronic communicator configured to communicate information between the liquid container and a separate electronic device.

5. The drinking receptacle of claim 4, wherein the separate electronic device is capable of being remote from the drinking receptacle.

6. The drinking receptacle of claim 5, wherein the separate electronic device is a mobile electronic device.

7. An electronically enabled drinking system comprising:
a liquid container;
an electronic processor;
an electronic drinking monitor; and
an electronic user-communicator;
an app on an electronic device separate from the liquid container;
wherein the drinking monitor is configured to provide information to the electronic processor regarding the liquid container and the electronic processor is configured to communicate the information to the app on the electronic device.

8. A combination of the electronically enable drinking system of claim 7 and the electronic device separate from the liquid container.

9. The combination of claim 8 wherein the electronic device is a mobile electronic device.

10. The combination of claim 9 wherein the mobile electronic device is a wearable mobile electronic device.

11. The combination of claim 10 wherein the wearable mobile electronic device is a watch or a wristband.

12. A system of electronically enabled drinking receptacles comprising:
a plurality of drinking receptacles each comprising an electronic communicator and a user communicator;
wherein the drinking receptacles are configured to communicate electronically with each other through the electronic communicators and to communicate with one or more users using the user communicators.
